(19) United States
(12) Patent Application Publication
(10) Pub. No.: US 2026/0236835 A1
(43) Pub. Date: Aug. 13, 2026

(54) PRECURSOR LEARNING FOR LABEL REFINEMENT OF MACHINE LEARNING TRAINING SIGNALS

(71) Applicant: EQUIFAX INC., Atlanta, GA (US)

(72) Inventors: Ramin MADARSHAHIAN, Houston, TX (US); Matthew Lewis JONES, Boise, ID (US)

(21) Appl. No.: 19/156,681

(22) PCT Filed: Feb. 15, 2023
(86) PCT No.: PCT/US2023/062679

§ 371 Date: Aug. 14, 2025

(51) Int. Cl. G06N 20/00

(52) U.S. Cl. CPC G06N 20/00

(57) ABSTRACT

Systems and methods for improving machine learning model predictive capabilities relative to time dependent unbalanced datasets. A separately trained (precursor) data classification machine learning model is utilized to refine training data by removing the time dependence of certain data samples in a given dataset, identify initially misidentified or misclassified data samples, and accordingly, modify a supervisory signal associated with the data used relative to subsequently training a main machine learning model. Systems and methods according to aspects of the present disclosure improve the ability of the main machine learning model to make accurate predictions with respect time dependent unbalanced datasets, while requiring less memory and processor resources for training.

### TECHNICAL FIELD

The present disclosure relates generally to machine learning techniques, and more particularly, although not exclusively, to training techniques for improving machine learning model prediction capabilities relative to time dependent unbalanced datasets.

### BACKGROUND

Supervised machine learning requires correctly labeled data to properly train machine learning models. Unfortunately, in many cases, the only data available to train a machine learning model consists of highly unbalanced data sets, where one label class of a given dataset can be several orders of magnitude more common than others.

An additional problem occurs when a data sample in a training dataset is misclassified or mislabeled, for instance, because the reporting of negative signals is time dependent. In such a case, data samples in a dataset may be mislabeled at the time of machine learning model training if the data is sufficiently recent.

Training a machine learning model using highly unbalanced datasets, and datasets with mislabeled or misclassified data samples, can have significant negative effects on the subsequent predictive capabilities of the machine learning model. For example, a machine learning model trained in such a manner may not correctly detect minority class data, or may not properly recognize information patterns associated with a negative data sample.

### SUMMARY

Various aspects of the present disclosure provide systems and methods for improving the predictive capability of a machine learning model, particularly when analyzing a highly unbalanced dataset containing time dependent data samples. According to one example, a system can include a processor and a memory, such as a non-transitory computer-readable medium, which includes instructions that are executable by the processor to cause the processor to perform various operations. According to aspects of the present disclosure, the operations can include receiving a class-imbalanced example dataset comprising a multitude of individual majority class and minority class data samples previously collected during a first time interval, combine a number of the minority class data samples with a randomly selected similar number of the majority class data samples to create a balanced training dataset, and initiate training of a data classification machine learning model using the balanced training dataset. The operations can also include receiving a class-imbalanced main dataset comprising a multitude of individual majority class and minority class data samples previously collected during a second time interval that is shorter and more recent than the first time interval, and executing the trained data classification machine learning model on the majority class data samples of the class-imbalanced main data set to identify majority class data samples in the class-imbalanced main dataset that should be classified as minority class data samples. The operations may additionally include creating a refined dataset from the class-imbalanced main dataset by changing from majority class to minority class, the classification of each data sample that is identified by the trained data classification machine learning model as being a minority class data sample, and creating an updated main dataset by substituting the data samples of the refined dataset for the majority class data samples in the class-imbalanced main dataset. The operations may further include initiating training of a main machine learning model using the updated main dataset, whereafter the main machine learning model is able to make more accurate and consistent predictions when analyzing a highly unbalanced dataset containing time dependent data samples.

According to another example of the present disclosure, a non-transitory computer readable medium may contain instructions that are executable by a processor to cause the processor to perform operations. According to aspects of the present disclosure, the operations can include receiving a class-imbalanced example dataset comprising a multitude of individual majority class and minority class data samples previously collected during a first time interval, combine a number of the minority class data samples with a randomly selected similar number of the majority class data samples to create a balanced training dataset, and initiate training of a data classification machine learning model using the balanced training dataset. The operations can also include receiving a class-imbalanced main dataset comprising a multitude of individual majority class and minority class data samples previously collected during a second time interval that is shorter and more recent than the first time interval, and executing the trained data classification machine learning model on the majority class data samples of the class-imbalanced main data set to identify majority class data samples in the class-imbalanced main dataset that should be classified as minority class data samples. The operations may additionally include creating a refined dataset from the class-imbalanced main dataset by changing from majority class to minority class, the classification of each data sample that is identified by the trained data classification machine learning model as being a minority class data sample, and creating an updated main dataset by substituting the data samples of the refined dataset for the majority class data samples in the class-imbalanced main dataset. The operations may further include initiating training of a main machine learning model using the updated main dataset, whereafter the main machine learning model is able to make more accurate and consistent predictions when analyzing a highly unbalanced dataset containing time dependent data samples.

According to an additional example of the present disclosure, a method of improving machine learning model predictive capabilities relative to time dependent unbalanced datasets is provided. The method may include, receiving by a processing device, a class-imbalanced example dataset comprising a multitude of individual majority class and minority class data samples previously collected during a first time interval, combining, by the processing device, a number of the minority class data samples with a randomly selected similar number of the majority class data samples to create a balanced training dataset, and initiating, by the processing device, training of a data classification machine learning model using the balanced training dataset. The method may also include, receiving by the processing device, a class-imbalanced main dataset comprising a multitude of individual majority class and minority class data samples previously collected during a second time interval that is shorter and more recent than the first time interval, and executing by the processing device, the trained data classification machine learning model on the majority class data samples of the class-imbalanced main data set to identify majority class data samples in the class-imbalanced main dataset that should be classified as minority class data samples. The method may additionally include, creating by the processing device, a refined dataset from the class-imbalanced main dataset by changing from majority class to minority class, the classification of each data sample that is identified by the trained data classification machine learning model as being a minority class data sample, and creating by the processing device, an updated main dataset by substituting the data samples of the refined dataset for the majority class data samples in the class-imbalanced main dataset. The method may further include, initiating by the processing device, training of a main machine learning model using the updated main dataset, whereafter the main machine learning model is able to make more accurate and consistent predictions when analyzing a highly unbalanced dataset containing time dependent data samples.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of an operating environment for training a machine learning model to make accurate predictions relative to time-dependent unbalanced datasets.

FIG. 2 is a block diagram depicting an example of a computing system suitable for implementing certain aspects of the present disclosure.

FIG. 3 is a flow chart depicting an example of a process for training a machine learning model to make accurate predictions relative to time-dependent unbalanced datasets.

### DETAILED DESCRIPTION

Certain aspects and examples of the present disclosure are directed to machine learning training techniques for improving the ability of a machine learning model to make accurate predictions when analyzing data presented in highly unbalanced datasets containing data samples for which proper labeling is time dependent. For example, techniques according to aspects of the present disclosure may result in a main machine learning model that is trained using a recent and label-refined supervisory signal, which is label-refined using another (data classification) machine learning model trained on a balanced dataset created from data that is prior in time to the data used to train the main machine learning model. The balanced dataset contains historical minority class samples in addition to a similar number of randomly selected historical majority class samples. Since the prior in time data is old enough to contain historical minority class samples that are labeled as accurately as possible, training the data classification machine learning model on the balanced dataset, which includes historical minority class samples from the prior in time data, can be used to lessen the impact of time dependency on the supervisory signal utilized for training the main machine learning model using more recent data.

According to examples of the present disclosure, using a separately trained machine learning (precursor) model to refine training data by reducing the time dependence of certain data samples in a given dataset, identifying initially misidentified or mislabeled data samples, and accordingly modifying a supervisory signal associated with the data, which is subsequently used to train a main machine learning model, ultimately improves the ability of the main machine learning model to make accurate predictions.

According to other aspects of the present disclosure, precursor training using a smaller balanced training dataset can conserve computing resources. A typical dataset used to train a machine learning model may be extremely large. For example, some large training datasets may include as many as one hundred million data samples, with each data sample having hundreds of features. Consequently, creating one or more smaller balanced training datasets from a much larger unbalanced training dataset, and using a smaller balanced training dataset instead of the larger unbalanced dataset for training of the data classification machine learning model, is more efficient and also reduces the amount of memory and processor resources required for training. Training the data classification machine learning model on one or more balanced training datasets further allows the output of the data classification machine learning model to subsequently be used in creating an updated main dataset with properly labeled data samples, while analyzing and manipulating only a portion of the overall data samples present in the main dataset.

According to yet other aspects of the present disclosure, precursory data classification machine learning model training operations may also be performed offline, or by otherwise using memory and processor resources not allocated to the main machine learning model. This allows for the further conservation of memory and processor resources allocated to the main machine learning model.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

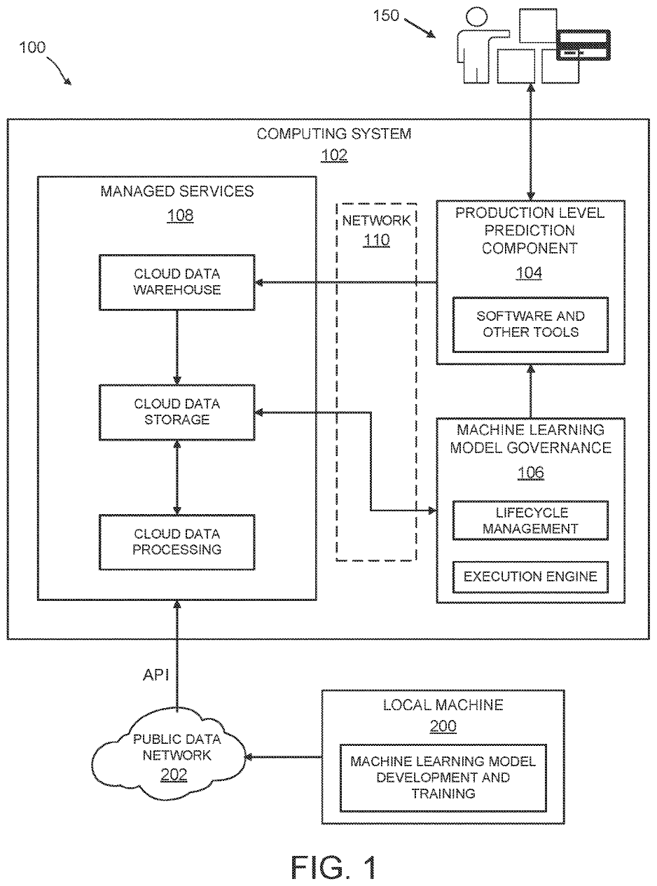

Referring now to the drawings, FIG. 1 is a block diagram depicting an example of an operating environment 100 in which a machine learning-based computing system 102 (also referred to hereinafter as “computing system 102”) can be utilized for machine learning model training and operation. More specifically, FIG. 1 depicts examples of hardware components of a computing system 102 according to some aspects of the present disclosure. The computing system 102 may be a specialized computing system that can be used for processing large amounts of data.

As shown in FIG. 1, the computing system 102 may include a production-level prediction component 104 that receives from one or more outside sources 150, incoming data for which predictions are required to be made in real time. The computing system 102 may also include a machine learning model governance component 106. The machine learning model governance component 106 may include subcomponents that perform various operations relative to the prediction component 104. For example, a subcomponent of the machine learning model governance component 106 may perform operations related to machine learning model lifecycle management. As another example, an execution engine subcomponent of the machine learning model governance component 106 may facilitate the productionizing of a machine learning pipeline so that data is properly received by the prediction component 104, and predictions, decisions, etc., are properly output therefrom.

As also indicated in FIG. 1, the computing system 102 may include a managed services component 108. The managed services component 108 may oversee cloud-level management, storage, and processing of data associated with, for example, machine learning model training and operation. In this regard, the managed services component 108 may include a cloud data warehouse subcomponent that may receive at least data from the prediction component 104 over a network 110, and may be responsible for data storage, data sharing, and other functions. The data received by the cloud data warehouse subcomponent from the prediction component 104 may include information such as, without limitation, information regarding predictions or assessments made relative to incoming data.

In this example of the computing system 102, the cloud data warehouse subcomponent may also be communicatively coupled to a cloud storage component for further purposes of storing electronic transaction or other data. The cloud data storage subcomponent may be any cloud object storage service. The cloud data storage subcomponent may communicate with the machine learning model governance component 106 over the network 110 at least so that, for example, the execution engine subcomponent of the machine learning model governance component 106 can receive required data during productionizing of machine learning pipelines.

As further indicated in FIG. 1, the managed services component 108 of the computing system 102 may also include a cloud data processing subcomponent. Given that machine learning model development and training can require the processing of significant amounts of data, the cloud data processing subcomponent may be designed to simplify the running of large-scale data processing jobs. The cloud data processing subcomponent is shown to be communicatively coupled to the cloud data storage subcomponent so that, for example, the cloud data processing subcomponent has access to stored data, and can also store data, during machine learning model development or training.

While not expressly shown in FIG. 1 for purposes of clarity, it should be apparent that communications between the cloud data warehouse subcomponent and the cloud data storage subcomponent, and between the cloud data storage subcomponent and the cloud data storage subcomponent, of the managed services component 108, occur over a network. Particularly, given that all of said managed services component 108 subcomponents are cloud-based subcomponents in this example, it should be apparent that said subcomponents may communicate over the Internet.

FIG. 1 further illustrates the interconnection of a local machine 200 with the computing system 102. In this example, the local machine 200 is in communication with the computing system 102 over a network, such as a public data network 202 shown. The local machine 200 may communicate at least with the managed services component 108 of the computing system 102, such that the local machine 200 has access to the data storage and data processing functionality of the managed services component 108.

The networks used for communication within the operating environment 100 of FIG. 1 may be different types of data networks, such as a public data network (e.g., public data network 202), a private data network (e.g., network) 110, or some combination thereof. A data network may include one or more of a variety of network types, including a wireless network, a wired network, or a combination of a wired and wireless network. Examples of suitable networks include, without limitation, the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices or components in the data network.

The number of components depicted in FIG. 1 is for illustrative purposes only. Different numbers and types of components may be used. For example, while certain components and subcomponents are shown as single components or subcomponents in FIG. 1, multiple components or subcomponents may be used instead. Similarly, it may be possible for components or subcomponents that are shown to be separate, such as for example, the cloud data warehouse and cloud data storage subcomponents, may be instead implemented in a signal component or subcomponent.

According to an aspect of the present disclosure, a user may perform machine learning model development and training using the local machine 200. For example, the local machine may be used to develop the above-described data classification machine learning model, the main machine learning model, or both. In some examples, testing and training of machine learning models may also be performed on the local machine 200 using the memory and processor resources of the local machine 200. In other examples, particularly where a machine learning model is complex or a dataset required to train a machine learning model is large, the local machine 200 may utilize the cloud data storage subcomponent of the managed services component 108 for data retrieval and storage purposes. Likewise, the local machine 200 may take advantage of the data processing capabilities of the cloud data processing subcomponent of the managed services component 108 when testing or training a given machine learning model.

As one example, a user may perform machine learning model development and training using the local machine 200, by executing an application (e.g., processor executable instructions) on the local machine 200. The application can cause the processor of the local machine 200 to first receive a class-imbalanced example dataset comprising numerous data points for each of a multitude of data samples previously collected during a first time interval. As an example, and without limitation, the first time interval relative to the example dataset may be from six months ago to one month ago. Other time intervals are also possible.

Depending on the size of the example dataset, the example dataset may be received by the processor from a memory location of the local machine 200. Alternatively, if desired because the example dataset is large and/or in order to conserve local machine memory and processor resources, the example dataset may be received by the processor of the local machine 200 from the cloud data storage subcomponent or cloud data warehouse subcomponent of the managed services component 108 of the computing system 102, or from another web-based data store (not shown) in communication with the local machine 200.

The processor of the local machine 200 may then be caused to sort individual data samples represented in the example dataset into a minority class group or a majority class group according to classification data points associated with each data sample, to combine minority class data samples with a similar number of randomly selected majority class data samples, and to create a balanced training dataset from the combined data samples. The processor may subsequently be caused to initiate training of a data classification (precursor) machine learning model using the balanced training dataset, where the data classification machine learning model has been developed and configured to analyze the data points of the data samples in the balanced training dataset, and to resultantly predict whether a given data sample of the multitude of data samples in the balanced training dataset is a minority class data sample. Training of the data classification machine learning model on the balanced training dataset results in a trained data classification machine learning model. In an alternative example, each or all of the sorting of data samples, creation of a balanced training dataset, and training of the data classification machine learning model on the balanced training dataset, may instead be performed by a processor of the cloud data processing subcomponent of the computing system 102, at the direction of the application on the local machine 200.

Examples of a data classification machine learning model according to aspects of the present disclosure, can predict that a given data sample of the multitude of data samples in the balanced training dataset is a minority class data sample when an output of the data classification machine learning model relative to the given data sample exceeds a preselected threshold value. Similarly, examples of a trained data classification machine learning model according to aspects of the present disclosure, can determine that a given extracted data sample in the refined dataset is a minority class data sample when an output of the trained data classification machine learning model relative to the given extracted data sample exceeds the preselected threshold value.

The threshold value may be used to calibrate how aggressively the labels of certain majority class data samples are changed to minority class data samples when creating an updated main data set, as described in more detail below. According to at least some aspects of the present disclosure, the threshold value may be considered a hyperparameter with respect to precursor training by the data classification machine learning model. According to at least some system and method examples, the preselected threshold value can be variable and can be a value between zero and one.

The application may further cause the processor of the local machine 200 to receive a class-imbalanced main dataset comprising data sample information for each of a multitude of data samples previously collected during a second time interval that is shorter and more recent than the first time interval associated with the example dataset. As an example, and without limitation, the second time interval relative to the main dataset may be the past 30 days. Other time intervals are also possible.

Depending on its size, the main dataset may be received by the processor from a memory location of the local machine 200. Alternatively, if desired because the main dataset is large and/or in order to conserve local machine memory and processor resources, the main dataset may be received by the processor of the local machine from the cloud data storage subcomponent or cloud data warehouse subcomponent of the managed service component 108 of the computing system 102, or from another web-based data store (not shown) in communication with the local machine 200.

The application may then cause the processor of the local machine 200 to execute the trained data classification machine learning model on the majority class data samples of the main data set to identify majority class data samples in the main dataset that should be classified as minority class data samples. The application may further cause the processor of the local machine 200 to create a refined dataset from the class-imbalanced main dataset by changing from majority class to minority class, the classification of each data sample that is identified by the trained data classification machine learning model as being a minority class data sample. The refined dataset may be saved, such as in memory of the local machine 200, or at the cloud data storage subcomponent or cloud data warehouse subcomponent of the computing system 102.

The application may further cause the processor of the local machine 200 to create an updated main dataset by substituting the data samples of the refined dataset for the majority class data samples in the class-imbalanced main dataset, and to initiate training of a main machine learning model using the updated main dataset. Training of the main machine learning model using the updated main dataset, results in a trained main machine learning model. As with previous operations, creation of the updated main dataset, and initiating training of the main machine learning model using the updated main dataset, may alternatively be performed by a processor of the cloud data processing subcomponent of the computing system 102, at the direction of the application on the local machine 200.

In response to initiating training of the main machine learning model using the updated main dataset, the application can cause the processor of the local machine 200 to receive a trained main machine learning model. The application can then cause the processor of the local machine 200 to, for example, transmit the trained machine learning model to a production level location in the computing system 102, where the trained main machine learning model operates to provide real time predictions relative to newly received data samples.

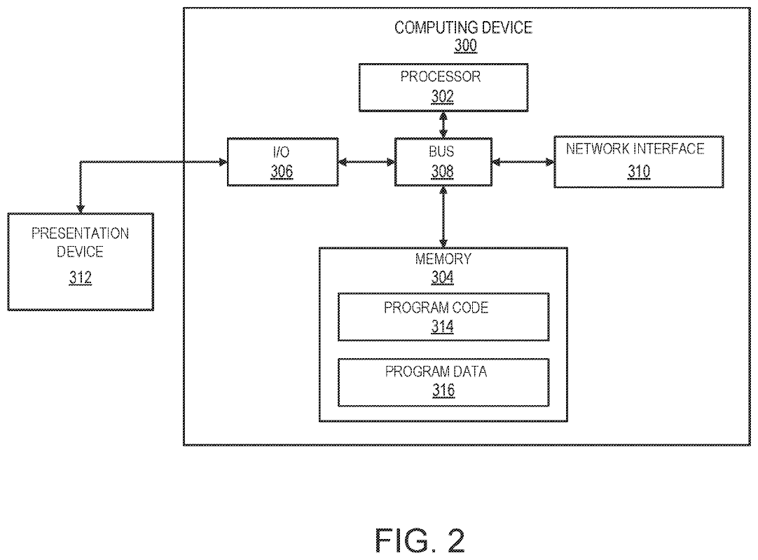

Any suitable computing system or group of computing systems can serve as and perform the operations of the local machine 200 described herein. In this regard, FIG. 2 is a block diagram depicting one example of a computing device 300, which can serve as the local machine 200 and can be used to perform machine learning model development, training, and testing operations, alone or in conjunction with assistance from one or more subcomponents of the managed services component 108 of the computing system 102, as described above. For example, the computing device 300 may be used to develop, train, and test different examples of the data classification machine learning model according to aspects of the present disclosure. The computing device 300 may also be used to develop, train, and test new main machine learning models, or to modify or otherwise operate on an existing main machine learning model.

The computing device 300 can include various devices for communicating with other devices in the operating environment 100, as described with respect to FIG. 1. As shown in FIG. 2, the computing device 300 can include a processor 302 that is communicatively coupled to a memory 304. The processor 302 can execute computer-executable program code stored in the memory 304, can access information stored in the memory 304, or both. The memory 304 can store program code in the form of instructions that, when executed by the processor 302, causes the processor 302 to perform the operations described herein. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 302 can include a microprocessor, an application-specific integrated circuit (ASIC), a field-programmable gate array (FPGA), or any other suitable processing device. The processor 302 can include any suitable number of processing devices, including one. In addition to communicating with the memory 304, the processor 302 can include a memory.

The memory 304 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C #, Visual Basic, Java, Python, Perl, JavaScript, ActionScript, etc.

The computing device 300 may also include a number of external or internal devices such as input or output devices. For example, the computing device 300 is illustrated with an input/output interface 306 that can receive input from input devices or provide output to output devices. A bus 308 can also be included in the computing device 300. The bus 308 can communicatively couple one or more components of the computing device 300.

In some examples, the computing device 300 can include one or more output devices. One example of such an output device may be the network interface device 310. A network interface device 310 can include any device or group of devices suitable for establishing a wired or wireless data connection to one or more data networks, such as but not limited to, the public data network 202 depicted in FIG. 1. Non-limiting examples of the network interface device 310 can include an Ethernet network adapter, a modem, etc.

Another example of an output device can include a presentation device, such as the presentation device 312 depicted in FIG. 2. A presentation device 312 can include any device or group of devices suitable for providing visual, auditory, or other suitable sensory output. Non-limiting examples of the presentation device 312 can include a touchscreen, a monitor, a speaker, a separate mobile computing device, etc.

As further represented in FIG. 2, the computing device 300 can execute program code 314 that includes instructions to cause the processor 302 of the computing device 300 to perform the various data classification, data refinement, and machine learning model training operations described herein. For example, the instructions in the program code 314 may cause the processor to: sort individual data samples represented in a received example dataset into a minority class group or a majority class group; combine minority class data samples with randomly selected majority class data samples to form a balanced training dataset; initiate training of a data classification machine learning model using the balanced training dataset; execute the trained data classification machine learning model on majority class data samples of a received class-imbalanced main data set to identify majority class data samples in the class-imbalanced main dataset that should be classified as minority class data samples; create a refined dataset from the class-imbalanced main dataset by changing certain data sample labels for proper classification; create an updated main dataset by substituting the data samples of the refined dataset for the majority class data samples in the class-imbalanced main dataset; initiate training of a main machine learning model using the updated main dataset, A trained main machine learning model may be subsequently received.

The program code 314 may be resident in any suitable computer-readable medium, such as a non-transitory computer readable medium, and may be executed on any suitable processing device. For example, as depicted in FIG. 2, the program code 314 for performing the various operations described herein can reside in the memory 304 of the computing device 300 along with program data 316 associated with the program code 314. Executing a machine learning model training application on the computing device 300 can configure the processor 302 to perform the operations described herein.

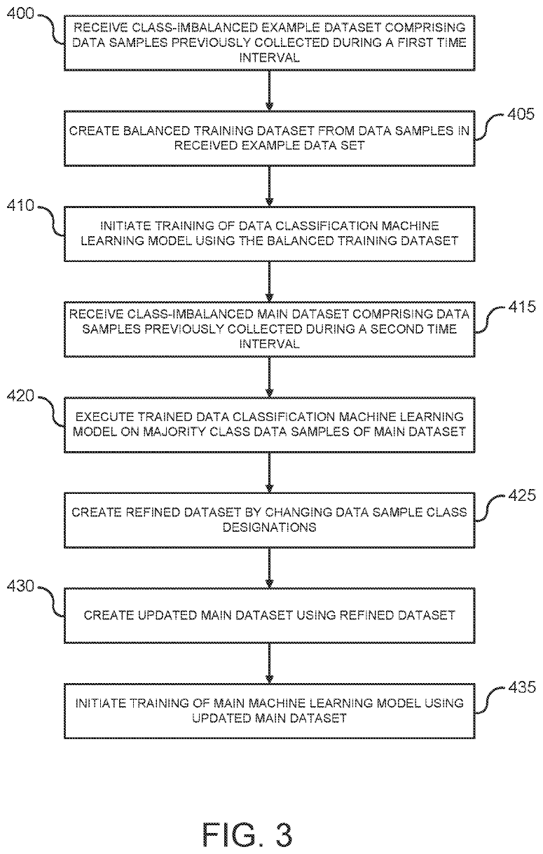

One example of a method of improving machine learning model predictive capabilities relative to time dependent unbalanced datasets is illustrated as a flow chart in FIG. 3. The example method can include, as depicted at block 400, receiving by a processing device, a class-imbalanced example dataset comprising a multitude of individual majority class and minority class data samples previously collected during a first time interval, and at block 405, combining by the processing device, a number of the minority class data samples with a randomly selected similar number of the majority class data samples to create a balanced training dataset. The method can also include, as represented at block 410, initiating by the processing device, training of a data classification machine learning model using the balanced training dataset.

At block 415, the method can additionally include receiving, by the processing device, a class-imbalanced main dataset comprising a multitude of individual majority class and minority class data samples previously collected during a second time interval that is shorter and more recent than the first time interval. According to block 420, the method can also include executing by the processor, the trained data classification machine learning model on the majority class data samples of the class-imbalanced main data set to identify majority class data samples in the class-imbalanced main dataset that should be classified as minority class data samples.

According to block 425, the method can further include creating, by the processing device, a refined dataset from the class-imbalanced main dataset by changing from majority class to minority class, the classification of each data sample that is identified by the trained data classification machine learning model as being a minority class data sample. As indicated at block 430, the method can still further include creating an updated main dataset by substituting the data samples of the refined dataset for the majority class data samples in the class-imbalanced main dataset. Although not shown in the flow chart of FIG. 3, one or both of the refined dataset and the updated main dataset, may be saved, such as in memory of the local machine 200 or at one or both of the cloud data warehouse component or cloud data storage components of the computing system 102 depicted in FIG. 1.

At block 435, the method can yet further include initiating by the processing device, the training of a main machine learning model using the updated main dataset. By this method example, the main machine learning model can be trained to make more accurate and consistent predictions when analyzing a highly unbalanced dataset containing time dependent data samples.

System and method examples according to the present disclosure may be used to train machine learning models utilized for many different purposes. As one example, and without limitation, system and method examples according to the present disclosure may be used to train machine learning models to provide a fraud assessment of electronic transactions, such as but not limited to, online electronic credit card transactions. Undetected fraudulent transactions are detrimental to merchants, to credit providers, and others, and may drive up the cost of goods for legitimate purchasers. As such, detecting fraudulent electronic transactions is an important, albeit complicated, undertaking.

The detection of fraudulent electronic transactions can be difficult, particularly in the case of online electronic transactions where there is no in-person interaction between a merchant and a purchaser. The sheer volume of electronic transactions that occur on a daily basis also contributes to difficulties in fraud detection. Nonetheless, electronic transaction service providers and others may go to significant effort to detect fraud, and when possible, to deny fraudulent transactions in real time.

Machine learning models can be effective mechanisms for combatting electronic transaction fraud. However, providing supervised machine learning with correctly labeled or classified data or balanced datasets can be problematic in the context of training machine learning models to detect fraudulent electronic transactions because, in many cases, the data available to train a fraud detection machine learning model is a highly unbalanced dataset, where one category of electronic transactions in the dataset is present in a far greater number than another category of electronic transactions.

As one example, in a typical dataset including a multitude of processed electronic transactions, the electronic transactions categorized as non-chargeback (i.e., non-fraudulent) transactions will greatly outnumber electronic transactions categorized as chargeback transactions, which are considered to be fraudulent transactions. In this regard, it would not be unexpected that a dataset containing a large number of processed electronic transactions may include approximately one thousand or more non-chargeback type transactions for each indicated chargeback type transaction present in the dataset. Such an imbalance in the data used to train a fraud detection machine learning model can obscure fraud-indicating patterns in the data and allow the minority class of data (e.g., chargeback transactions) to circumvent detection.

Due to rapidly fluctuating trends in electronic transaction fraud patterns resulting from fraudsters attempting to circumvent the state-of-the-art in fraud protection, it is generally prudent to train fraud detection machine learning models on the most recent electronic transaction data available. However, this conflicts with the temporal nature of certain fraud indication signals such as, for example, chargebacks, refunds, or other sources of fraud for which proper data sample classification/labeling is often time dependent and may be delayed. For example, and without limitation, due to typical delays in reporting, the number of electronic transactions classified as chargeback type transactions in a dataset containing electronic transactions processed over an immediately preceding 30-day period may be almost three times less than the number of electronic transactions classified as chargeback type transactions in a dataset containing electronic transactions processed over a like period of 30 days, but from four months prior.

As a result of time dependency and other above-described data peculiarities, the frequency of certain fraud indication signals in recently processed electronic transaction data is commonly too low to properly train a fraud detection machine learning model, and many fraudulent transactions (e.g., chargeback transactions) present in recently processed electronic transaction data are incorrectly classified as non-fraudulent transactions. Unfortunately, when electronic transactions that have been incorrectly classified as non-fraudulent (i.e., having a risk of 0.0) are finally reported as being fraudulent (i.e., having a risk of 1.0), the machine learning supervisory signal is contaminated and the predictive power of the fraud detection machine learning model is diminished.

System and method examples according to the present disclosure can alleviate some of the problems mentioned above with respect to detecting fraudulent electronic transactions. For example, when the computing environment 100 of FIG. 1 is designed for and applied to the problem of detecting fraud in electronic transactions, the computing system 102 may be a fraud detection computing system, the prediction component 104 may be a production level fraud detection component that may include other fraud detection software and prevention tools, and the production level fraud detection component may analyze and assess newly received electronic transaction processing requests from outside sources 150 in the form of online merchants, brick-and-mortar merchants, etc.

In the case of system and method examples according to the present disclosure that are applied to electronic transaction fraud detection, the data samples in the data sets may be processed electronic transactions, and each of the class-imbalanced example dataset and the class-imbalanced main dataset may be imbalanced in a manner such that majority class electronic transactions in the datasets far outnumber minority class electronic transactions. Further, the majority class electronic transactions may be non-fraudulent electronic transactions, and the minority class electronic transactions may be fraudulent electronic transactions in the form of chargebacks.

When applied to electronic transaction data, as described above, system and method examples according to the present disclosure can operate to better balance the non-fraudulent and fraudulent chargeback electronic transactions in the datasets prior to training of the respective machine learning models. Likewise, precursor training of the data classification machine learning model and use thereof to produce an updated main data set for training of the main machine learning model, can be operative to remove any time dependencies associated with chargeback transactions, which results in a main machine learning model that can more accurately predict the presence of undetected chargeback transactions in datasets containing recently processed electronic transactions.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a non-transitory computer-readable medium comprising instructions that are executable by the processor to cause the processor to:
receive a class-imbalanced example dataset comprising a multitude of individual majority class and minority class data samples previously collected during a first time interval;
combine a number of the minority class data samples with a randomly selected similar number of the majority class data samples to create a balanced training dataset;
initiate training of a data classification machine learning model using the balanced training dataset;
receive a class-imbalanced main dataset comprising a multitude of individual majority class and minority class data samples previously collected during a second time interval that is shorter and more recent than the first time interval;
execute the trained data classification machine learning model on the majority class data samples of the class-imbalanced main data set to identify majority class data samples in the class-imbalanced main dataset that should be classified as minority class data samples;
create a refined dataset from the class-imbalanced main dataset by changing, from majority class to minority class, a classification of each data sample that is identified by the trained data classification machine learning model as being a minority class data sample;
create an updated main dataset by substituting the data samples of the refined dataset for the majority class data samples in the class-imbalanced main dataset; and
initiate training of a main machine learning model using the updated main dataset.

2. The system of claim 1, wherein the minority class data samples in the example dataset and the minority class data samples in the main data set are a type of data sample for which proper classification is time dependent.

3. The system of claim 1, wherein:
the data classification machine learning model is configured to predict that a given data sample of the multitude of data samples in the balanced training dataset is a minority class data sample when an output of the data classification machine learning model relative to the given data sample in the balanced training dataset exceeds a preselected threshold value;
the trained data classification machine learning model is configured to determine that a given data sample in the refined dataset is a minority class data sample when an output of the data classification machine learning model relative to the given data sample in the refined dataset exceeds the preselected threshold value; and
the preselected threshold value is variable and between zero and one.

4. The system of claim 1, wherein:
the first time interval associated with the example data set is from six months ago to one month ago; and
the second time interval associated with the main data set is the past 30 days.

5. The system of claim 1, wherein the minority class data samples are online electronic credit card transactions.

6. The system of claim 5, wherein the online electronic credit card transactions are fraudulent transactions in the form of chargebacks.

7. A non-transitory computer-readable medium comprising instructions that are executable by a processor for causing the processor to:
receive a class-imbalanced example dataset comprising a multitude of individual majority class and minority class data samples previously collected during a first time interval;
combine a number of the minority class data samples with a randomly selected similar number of the majority class data samples to create a balanced training dataset;
initiate training of a data classification machine learning model using the balanced training dataset;
receive a class-imbalanced main dataset comprising a multitude of individual majority class and minority class data samples previously collected during a second time interval that is shorter and more recent than the first time interval;
execute the trained data classification machine learning model on the majority class data samples of the class-imbalanced main data set to identify majority class data samples in the class-imbalanced main dataset that should be classified as minority class data samples;
create a refined dataset from the class-imbalanced main dataset by changing, from majority class to minority class, a classification of each data sample that is identified by the trained data classification machine learning model as being a minority class data sample;
create an updated main dataset by substituting the data samples of the refined dataset for the majority class data samples in the class-imbalanced main dataset; and
initiate training of a main machine learning model using the updated main dataset.

8. The non-transitory computer-readable medium of claim 7, wherein the minority class data samples in the example dataset and the minority class data samples in the main data set are a type of data sample for which proper classification is time dependent.

9. The non-transitory computer-readable medium of claim 7, wherein:
the data classification machine learning model is configured to predict that a given data sample of the multitude of data samples in the balanced training dataset is a minority class data sample when an output of the data classification machine learning model relative to the given data sample in the balanced training dataset exceeds a preselected threshold value;
the trained data classification machine learning model is configured to determine that a given data sample in the refined dataset is a minority class data sample when an output of the data classification machine learning model relative to the given data sample in the refined dataset exceeds the preselected threshold value; and
the preselected threshold value is variable and between zero and one.

10. The non-transitory computer-readable medium of claim 7, wherein:
the first time interval associated with the example data set is from six months ago to one month ago; and
the second time interval associated with the main data set is the past 30 days.

11. The non-transitory computer-readable medium of claim 7, wherein the minority class data samples are online electronic credit card transactions.

12. The non-transitory computer-readable medium of claim 11, wherein the online electronic credit card transactions are fraudulent transactions in the form of chargebacks.

13. A method of improving machine learning model predictive capabilities relative to time dependent unbalanced datasets, the method comprising:
receiving, by a processing device, a class-imbalanced example dataset comprising a multitude of individual majority class and minority class data samples previously collected during a first time interval;
combining, by the processing device, a number of the minority class data samples with a randomly selected similar number of the majority class data samples to create a balanced training dataset;
initiating, by the processing device, training of a data classification machine learning model using the balanced training dataset;
receiving, by the processing device, a class-imbalanced main dataset comprising a multitude of individual majority class and minority class data samples previously collected during a second time interval that is shorter and more recent than the first time interval;
executing, by the processing device, the trained data classification machine learning model on the majority class data samples of the class-imbalanced main data set to identify majority class data samples in the class-imbalanced main dataset that should be classified as minority class data samples;
creating, by the processing device, a refined dataset from the class-imbalanced main dataset by changing, from majority class to minority class, a classification of each data sample that is identified by the trained data classification machine learning model as being a minority class data sample;
creating, by the processing device, an updated main dataset by substituting the data samples of the refined dataset for the majority class data samples in the class-imbalanced main dataset; and
initiating, by the processing device, training of a main machine learning model using the updated main dataset.

14. The method of claim 13, wherein the minority class data samples in the example dataset and the minority class data samples in the main data set are a type of data sample for which proper classification is time dependent.

15. The method of claim 13, wherein:
the data classification machine learning model predicts that a given data sample of the multitude of data samples in the balanced training dataset is a minority class data sample when an output of the data classification machine learning model relative to the given data sample in the balanced training dataset exceeds a preselected threshold value;
the trained data classification machine learning model predicts that a given data sample in the refined dataset is a minority class data sample when an output of the data classification machine learning model relative to the given data sample in the refined dataset exceeds the preselected threshold value; and
the preselected threshold value is variable and between zero and one.

16. The method of claim 13, wherein:
the first time interval associated with the example data set is from six months ago to one month ago; and
the second time interval associated with the main data set is the past 30 days.

17. The method of claim 13, wherein the minority class data samples are online electronic credit card transactions.

18. The method of claim 17, wherein the online electronic credit card transactions are fraudulent transactions in the form of chargebacks.

19. The method of claim 13, further comprising:
transmitting, by the processing device, the trained main machine learning model to a production level fraud detection component of a fraud detection computing system;
executing, by the production level fraud detection component of the fraud detection computing system, the main machine learning model on a newly received electronic transaction processing request; and
determining, by the trained main machine learning model, a fraud assessment of the newly received electronic transaction processing request.

20. The method of claim 19, further comprising approving or denying the newly received electronic transaction processing request based on the fraud assessment of the trained main machine learning model.
